(19) United States
(12) Patent Application Publication
(10) Pub. No.: US 2015/0309543 A1
(43) Pub. Date: Oct. 29, 2015

(54) COMPUTERIZED SHOWER UNIT FOR MULTI-MEDIA AND INTERNET

(71) Applicant: MATTHEW BLEISTERN, Merrick, NY (US)

(72) Inventor: MATTHEW BLEISTERN, Merrick, NY (US)

(21) Appl. No.: 14/259,681

(22) Filed: Apr. 23, 2014

(51) Int. Cl. G06F 1/18; G06F 1/16; A47K 3/28

(52) U.S. Cl. CPC G06F 1/182; A47K 3/281; G06F 1/1605

(57) ABSTRACT

A waterproof shower system 10 for installing in a shower to provide multiple functions, including a housing unit having at least one microphone 12 for receiving voice commands for operating the system; a touch panel 14 having operating buttons for also manually operating the system; a display screen 18 connected to the system for displaying multiple functions, including video and audio controls, weather information, news, and sports information. and social media information; a power source for providing power to the system; a charging unit for recharging the shower system; a proximity sensor for turning the system on when the user approaches the system; a motion sensor for turning the system on when the user approaches the system; and a light sensor for turning the system on when the light is turned on; a processor 40 for controlling the operating software, and the video and the audio functions of the system; and memory units 50 including a RAM unit 52. a ROM unit 54, a video/graphics RAM unit 56, and a solid-state storage memory unit 58 for long-term, non-volatile storage.

### FIELD OF THE INVENTION

The present invention relates to a portable, waterproof, electronic, and computerized shower system to provide multiple functions, such as video, audio, and weather, news, sports, and media information.

### BACKGROUND OF THE INVENTION

Conventional shower radios are limited in their content selection, as they rely on traditional broadcasts—typically AM & FM (or FMHD) stations—for content. This is not the ideal product for the ever-connected consumer who is now accustomed to on-demand content streaming and custom programming. Also, traditional AM/FM shower radios are outmoded; now, more than ever, users want a personalized listening experience.

The ideal user experience would be complete control of the shower device and its applications, where the user is free to change the content source or playlist at will. The shower listening and content experience is one of greatly unrealized potential. Traditional shower radio products are limited in content and are not user-friendly.

### OBJECTS OF THE INVENTION

It is an object of the present invention to provide a digital computing device designed to be an improvement to the conventional shower radio which provides more uses and applications.

It is a further object of the present invention to provide a wireless, water-resistant, internet-connected digital computing shower unit with built-in speaker(s) and a touch screen interface which is specially designed for safe, convenient, and user-friendly operation by those using the system in the shower.

It is a further object of the present invention to provide a control panel with a broad range of selection of content and affordability to the shower listening experience, which is an improvement to the current shower radio.

Another object of the present invention is to provide a control panel and software on the device which is easy to operate, having a touch screen interface and iconography that is easy to understand.

Another object of the present invention is to provide a highly adaptable device, capable of performing functions far beyond audio playback. The system runs a completely custom graphical user interface which is powered by the Google Android operating system. This means the device is capable of running a variety of specialized software applications to expand its usefulness and selection of content.

Another object of the present invention is to provide a device that has a natural human interface designed for enhanced, hands-free accessibility and activation by users in the shower. Two microphones are situated on the device to receive voice commands while canceling out any background noise. Applications on the device can read-aloud displayed data and instructions such as traffic and travel updates, weather information, tasks and to-dos, notes, stock quotes, social media posts, and sports scores. The device also employs proximity and motion sensors, so it can be activated by a user entering the shower, or go into low-power sleep mode when not in use. The device is designed to be ultra-power efficient, which enables the device to last weeks on a single charge of the battery.

It is a further object of the present invention to provide a shower unit which can be situated on a magnetic wall mount, or can be placed to stand on its own at the ledge of the basin. The device can be easily and readily removed from the wall during or after use, since the outermost edges of the device are rubberized and offer an enhanced grip as the device uses magnets to non-permanently attach to a securely mountable metallic plate. Once removed from the wall, the device can be stood upright for use on a countertop or by users bathing in the seated position. The ease of removing the device from the wall is no accident, and proves especially useful when it is time to charge the battery of the device, as it must be removed from its place on the wall of the shower and positioned on the battery charging base in order for the user to do so. Magnets secure alignment of the wireless inductive charging coils which are positioned interior to both the device and its charging dock. The base charges the device without the use of external metal contacts or wire tethers of any kind. Inductive charging (sometimes referred to as wireless charging) allows the device to operate in the steamy washroom environment.

Another object of the present invention is to provide protected connections. In an inductive charging configuration, all of the electronics are enclosed, so there are no exposed electrical contacts or parts at risk of corrosion. Further, inductive charging is more convenient for the user. Rather than having to first unplug a water-tight port protector and then connect a power cable, the device can be simply placed down onto a flat, wireless charging dock. Wireless charging makes the device safer and more durable. Plugging a power cable into a wet device could present an electric shock hazard. With inductive charging, there is very little risk of a short because there are not any exposed wires or plugs.

Another object of the present invention is to provide a housing which is highly water-resistant, which means it can occupy the shower or bath stall at all times, without modification by the user. For improved water-resistance and durability, the seam on the housing of the device is equipped with both an internal gasket as well as an outer rubberized layer. By using a touchscreen and microphone as input devices, the number of outwardly operated moving parts has been minimized to the two buttons used for volume, both of which have been rubberized and sealed. Further, the internal components are partitioned into water-tight compartments to limit the risk of exposing the most sensitive components (such as the system board, memory chips, and battery) to moisture. The device is equipped with WiFi and Bluetooth for data transfer, and inductive coils for contact-less charging of the battery. Therefore, there are no exposed electrical contacts, wiring sockets, or ports on the device. Because Input/output devices like the waterproof speaker and microphones rely on the movement of air, and therefore can never he fully sealed off, these components are protected by an impermeable and anti-microbial layer of vinyl. The thin layer of vinyl used has been treated with Vinyzene—the same chemical used in hospital shower curtains—making the device super anti-microbial. This layer of vinyl is positioned so that it seals off the circular speaker holes on the front of the housing, while still allowing enough vibration to pass through so that sound can be heard.

Another object of the present invention is to provide a low power consumption unit capable of lasting a few weeks without a new electric charge.

Another object of the present invention is to use an e-Ink technology to accomplish power efficiency.

### SUMMARY OF THE INVENTION

A waterproof shower system 10 for installing in a shower to provide multiple functions, including a housing unit having at least one microphone 12 for receiving voice commands for operating the system; a touch panel 14 having operating buttons for also manually operating the system; a display screen 18 connected to the system for displaying multiple functions, including video and audio controls, weather information, news, and sports information, and social media information; a power source for providing power to the system; a charging unit for recharging the shower system; a proximity sensor for turning the system on when the user approaches the system; a motion sensor for turning the system on when the user approaches the system; and a light sensor for turning the system on when the light is turned on; a processor 40 for controlling the operating software, and the video and the audio functions of the system; and memory units 50 including a RAM unit 52, a ROM unit 54, a video/graphics RAM unit 56, and a solid-state storage memory unit 58 for long-term, non-volatile storage.

### BRIEF DESCRIPTION OF THE DRAWINGS

FIG. 1 is a schematic diagram of the operating system of the present invention;

FIG. 2 is an exploded view of the control panel for the operating system;

FIG. 3 is an exploded view of the center panel 10g of the control panel of the present invention; and

FIGS. 4 to 11 show successive screens in the operation of the device.

### DETAILED DESCRIPTION OF THE PREFERRED EMBODIMENT

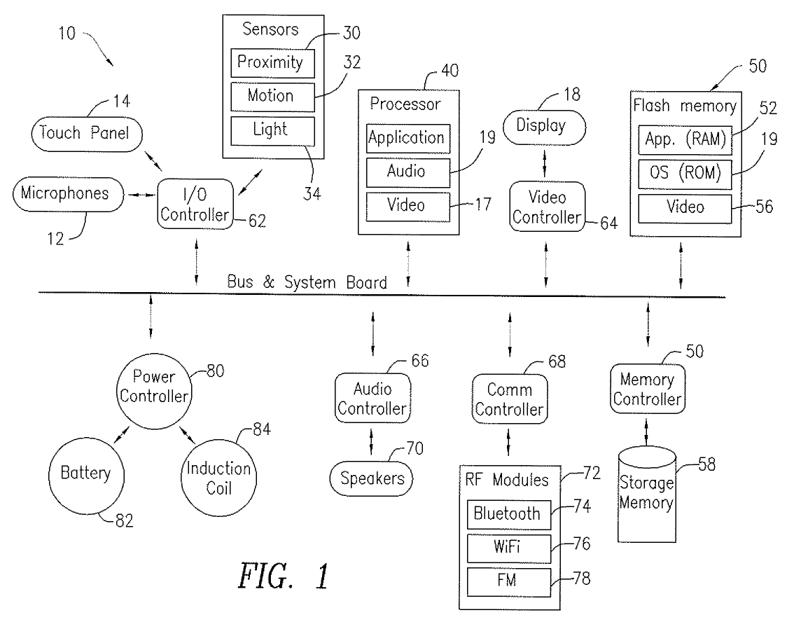

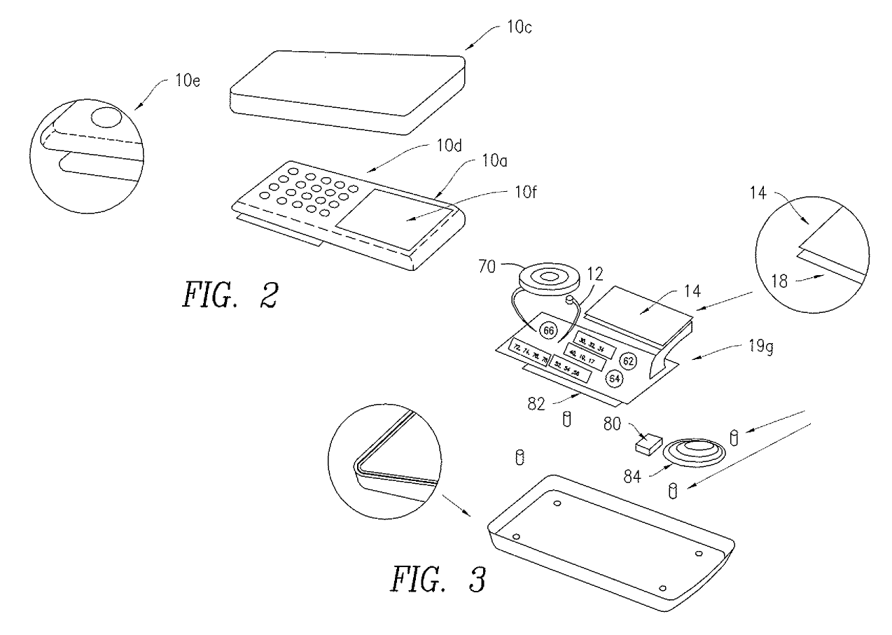

FIGS. 1 and 2 show the control panel of the present invention. The user controls the shower unit 10 with voice commands through microphones 12 to manipulate the software, or manually by touch panel 14. Touch panel 14 allows the device 10 to respond to touches to the icons and graphics displayed by the display screen 18. The device 10 also includes a power control button 80, a video controller 64, and an audio controller 66. Also, the volume is controlled by volume buttons 10d. Also, the shower unit timer has a display screen 18 for low-power consumption display using e-Ink technology to accomplish power efficiency. The display screen 18 displays the following functions: video and audio playback controls 17 and 19, as well as graphical display of weather, news, and other data, including but not limited to stocks, traffic, sports scores, and social media updates. Also, speakers 70 provide the audio output.

Further, the power is provided by power controller 80, the battery 82, and the induction coil 84. The audio controller 66 provides audio amplification and speakers 70 provide the audio output. An induction coil 26 provides the function of charging the shower unit 10 via electrical induction, where the shower unit 10 is placed on a fiat charging pad and re-charged without the use of a tether or any exposed electrical wires, contacts, or ports.

There are 3 sensors provided in the shower unit 10. A proximity sensor 30 is provided for turning on the shower unit when someone is within 3-5 feet of the unit, or whatever distance the user prefers and sets via the software as shower sizes vary. A motion sensor 32 is provided for also turning on the shower unit when it senses motion. Light sensor 34 is provided for performing the function of allowing the unit to be set up to turn on or take action when the lights are turned on in the room. Alternatively, the light sensor 34 also serves as a power-management function, dimming display lighting, or adjusting brightness to the appropriate settings based on ambient lighting conditions.

Processors 40 control the operating system, software, video, graphics, and audio functions of the shower unit by routinely routing computed data to and reading it from memory units 50 on the device. The memory units 50 includes a RAM unit 52 for providing temporary read-write storage of calculations and code executed by software applications running on the device, a ROM unit 54 for providing read-only storage of the operating system software, and a video/graphics RAM unit 56 for providing, temporary storage of the graphical and video data as it is being fed to the display screen, and a solid-state storage memory unit 58 for long-term, non-volatile storage of the software applications and their corresponding data.

As shown in FIGS. 1 and 2, the present invention also includes an I/O controller 62, a video controller 64, an audio controller 66 for controlling audio functions, speakers 70, a comm controller 68, RF modules 72, including a Bluetooth connection 74, a WiFi connection 76. and FM connection 78, a power controller 80, including a battery 82, and an induction coil 84.

The R/F modules or transreceivers 72 provide communication, including a Bluetooth chipset for allowing the unit 10 to wirelessly connect to accessories like smartphones.

FIG. 2 is an exploded view of the main housing or casing 10 which is made up of two case parts, front case 10a and back case 10b, of injection molded polycarbonate. When assembled, they are joined at the seam so that the two parts form a sealed clamshell, enveloping the internal components in a waterproof compartment. Each of the two case parts 10a and 10b feature a peripheral channel having a rubber outer band 10c and a gasket 10b fixed therein, so that it forms a waterproof seal at the junction of the two case parts, making the assembled housing or casing water-resistant. The rubberized outer band 10c provides the user with a surface with an enhanced grip, allowing for easy removal of the casing from its magnetic mount.

The physical attributes of the front casing 10a include holes which allow the speakers to be heard clearly, and rubberized volume+ and volume− buttons 10d, as well as several holes for the proximity sensor 30, ambient light detector 34, and motion sensors 32. Beneath these holes is an impermeable waterproof layer 10e made of anti-microbial Vinyzene. The Vinyzene layer 10e sits just below the front casing 10a fixed to it by adhesive, so that it is flush and sealed off from the outside environment. There is a transparent section 10f of a rectilinear shape at the right side, which allows the display screen 18 and touch panel 14 beneath it to be viewable through the housing, while at the same time protecting it from both moisture and impacts.

FIG. 3 also shows the center panel 10g having the following parts mounted thereon: microphone 12, touch panel 14, screen 18, audio controller 66. speakers 70, sensors 32. 34, and 36; processors 40, 19, and 17; memory units 52, 54, and 56; I/O controller 62, video controller 64, RF modules 72. 74, 76. and 78; battery 82, power controller 80, and induction coil 84, which are all interconnected by buss 96.

### OPERATION OF THE PRESENT INVENTION

In operation, the shower unit or system 10 can be preset as to a number of efatures, such as level of volume, preset internet settings, or preset video or audio settings. The proximity sensor 30 may also be preset to turn on the system when the user approaches.

During use, the system provides controls for changing the video, audio or volume, or for resetting what is being listened to or watched.

In this manner, the user can easily access the internet, or access any video or audio information while in the shower.

1. Initialization of the Unit for the First Time When it is New:

1) User can activate the device via either of the volume buttons on the front of the housing to turn the device on.

2) Through a series of initial setup pages, the user is instructed to add WiFi network information, streaming account and gmail credentials, and configure the settings for the device including the names of all users, and the ideal wake-from-sleepmode settings. User is also prompted to have the device “learn” it's user's voice by asking the user to repeat a few different commands aloud into the microphone of the device.

3) The user mounts a plate on the wall, or places the device down on the basin of the shower.

4) The device is then ready for daily use.

2. Daily Use of the Device:

1) User can activate the device—waking it from sleep—in any of the following ways:

turning the fights on in the bathroom, stepping into the shower, speaking a command, or pressing either of the two buttons on the front of the device.

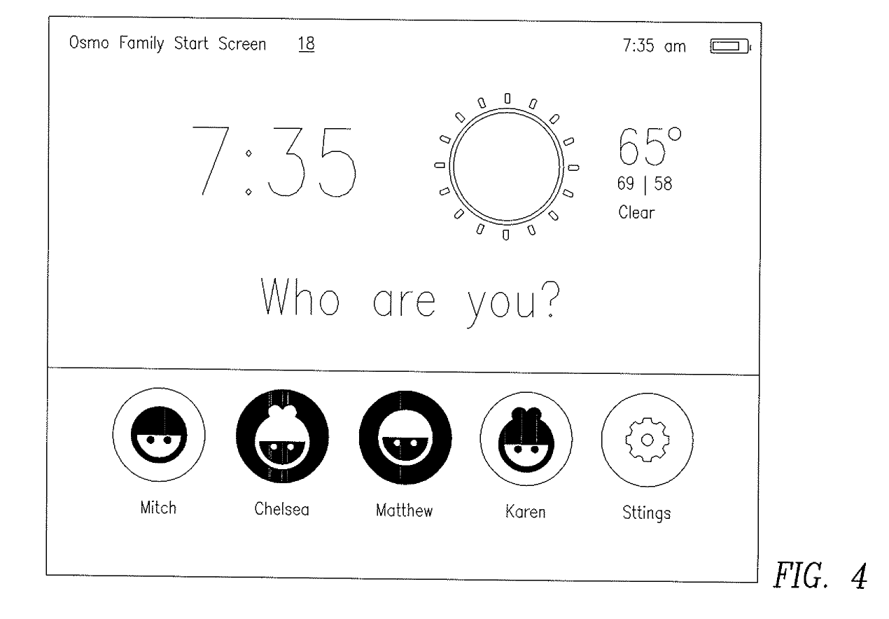

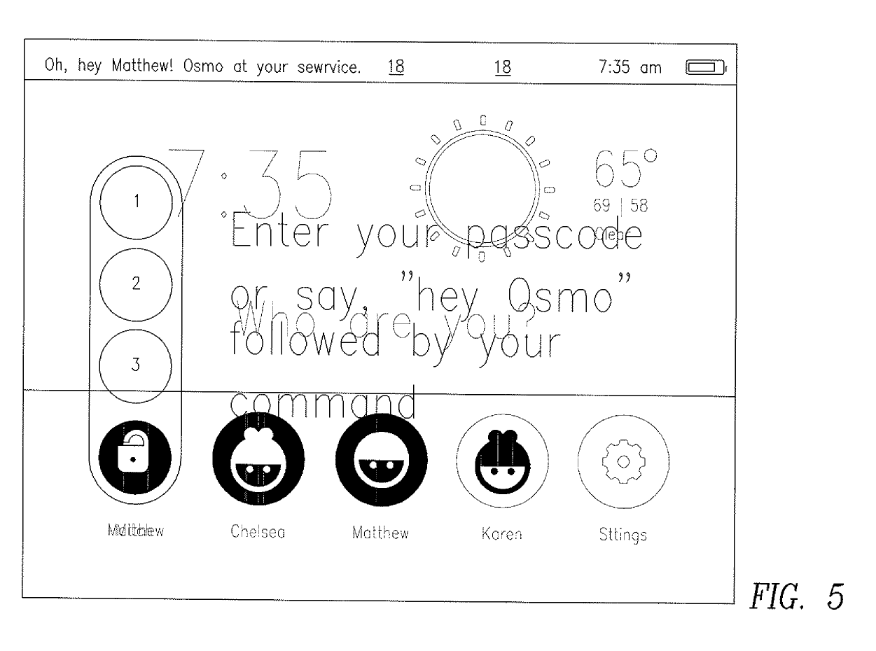

2) User is then presented with a welcome screen to select a user from a short list where each username is accompanied by a representative icon. See FIG. 4.

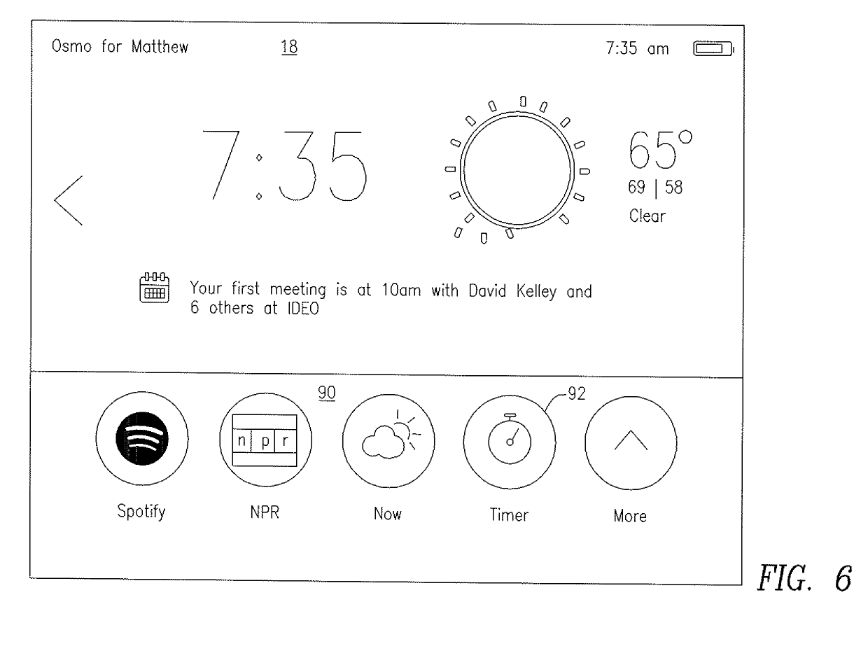

3) User then taps their username, and if a passcode is set, enters a 3-digit PIN. See FIG. 5.

4) The device is unlocked, and the home screen of the unit presents the user with a greeting, current weather conditions, the time, the date, the time and title of the user's first calendar appointment, as well as icons for quick access to applications, media content, timers, and settings. See FIG. 6.

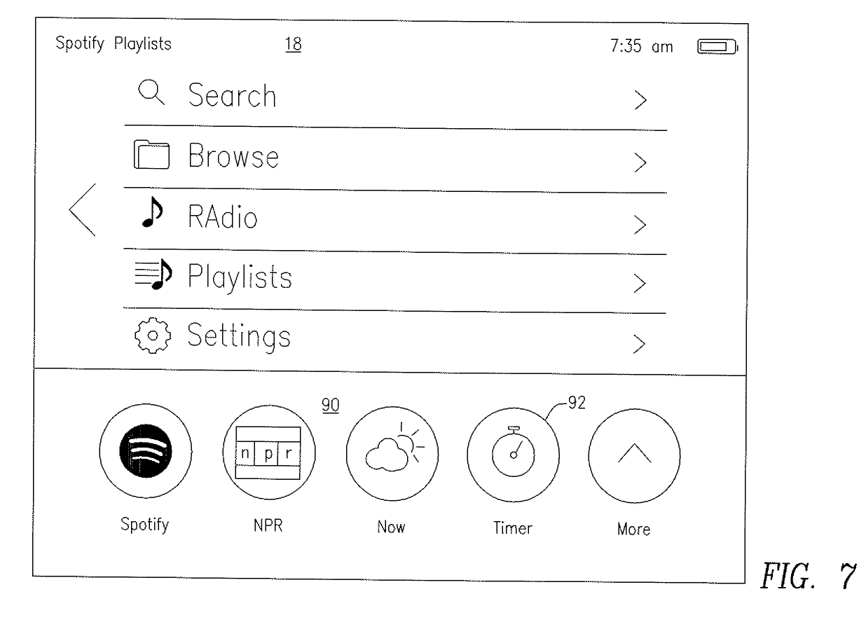

5) The user can then tap any application they would like, such and Browse, Radio, Playlists, etc., and the device will begin playback. See FIG. 7.

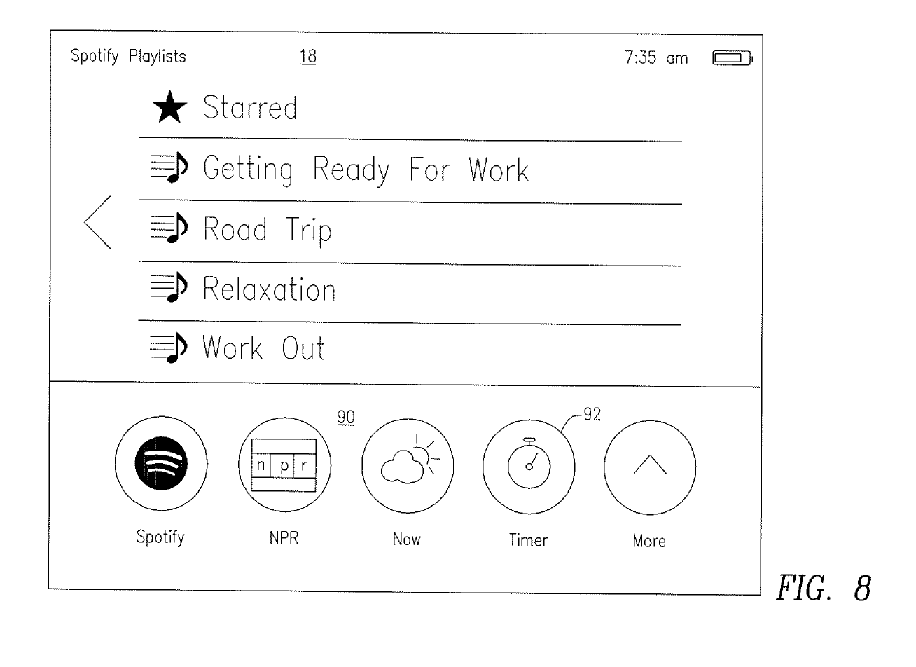

6) During playback, the icon tray from the home screen remains present, as does a small bar at the top of the screen. The icon tray 90 is there for easy access to other applications, as well as timers 92. The top bar persistently displays the time and current weather conditions, but may also contain an application (“new podcast now available;” “heavy traffic on the expressway;” “Yankees sweep the series” etc.) or system messages (“Low battery;” “Connected to Network:” etc.). See FIG. 8.

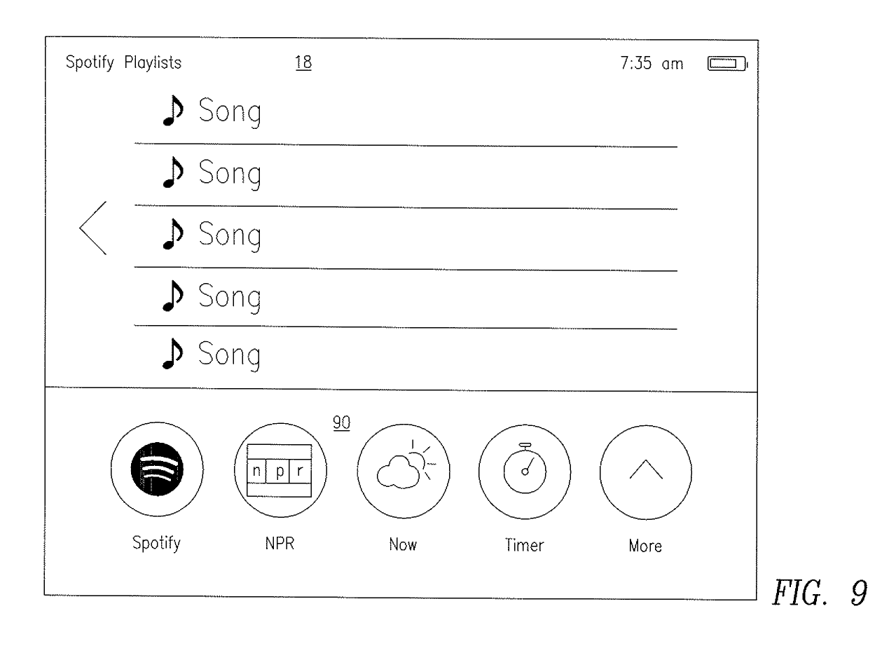

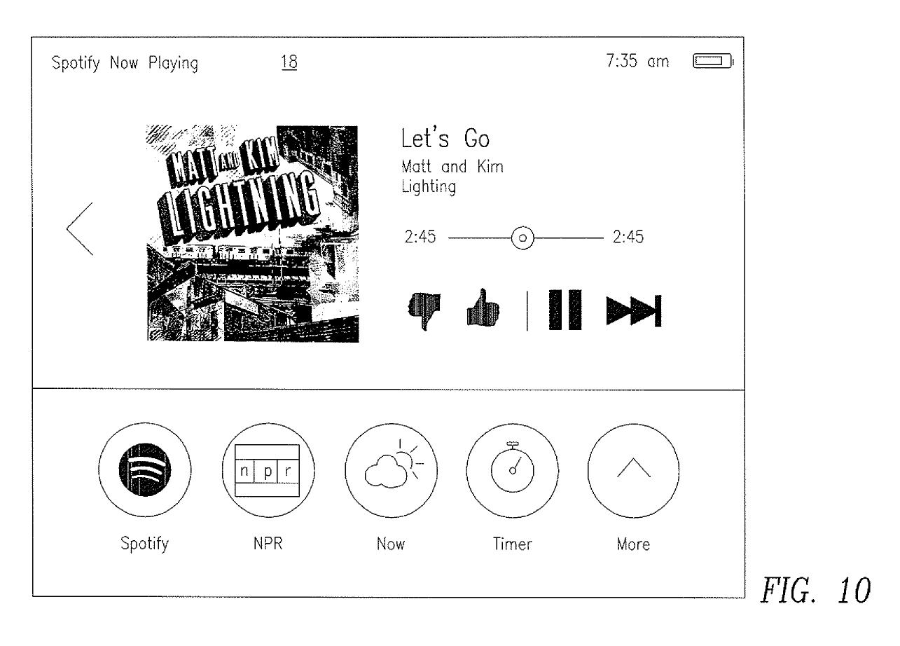

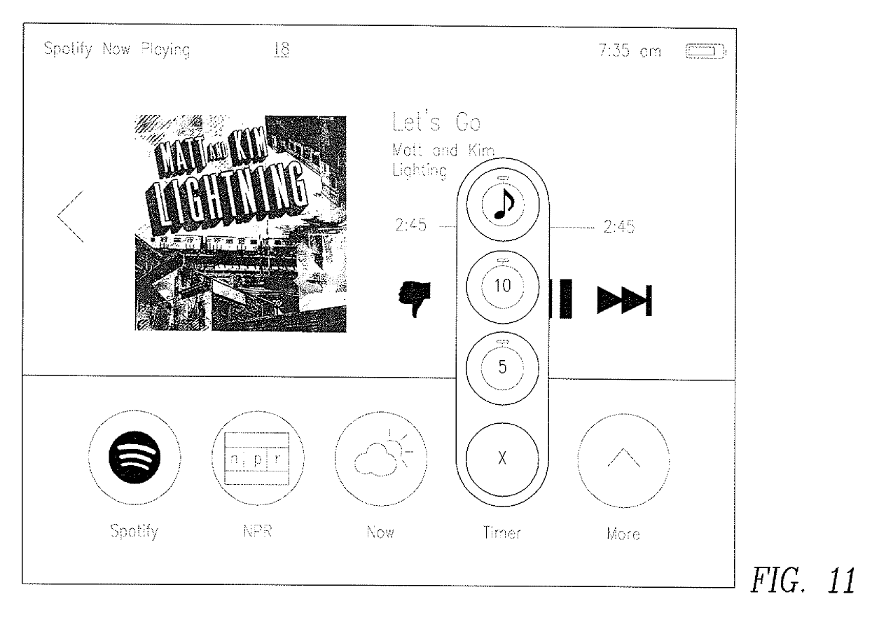

7) The user can set a timer that will remind them to get out of the shower, or the user can set a special timer, called a Smart Timer, which allows the system to display a time's up message at the conclusion of the current playback, whether that he a song, newscast, or other recording. See FIGS. 9, 10, and 11.

8) User enjoys music, and exits the shower.

### ADVANTAGES OF THE PRESENT INVENTION

The present invention has provided the advantage of a digital computing device designed to be an improvement to the conventional shower radio which provides more uses and applications.

The present invention has provided the advantage of a wireless, water-resistant, internet-connected digital computing shower unit with built-in speaker(s) and a touch screen interface which is specially designed for safe, convenient, and user-friendly operation by those using the shower.

The present invention has provided the advantage of a device with a broad range of selection of content and affordability to the shower listening experience, which is an improvement to the current shower radio.

The present invention has provided the advantage of software on the device which is easy to operate, having a touch screen interface and iconography that are easy to understand.

The present invention has provided the advantage of a highly adaptable device, capable of performing functions far beyond audio playback. The invention runs a completely custom graphical user interface which is powered by the Google Android operating system. This means the device is capable of running a variety of specialized software applications to expand its usefulness and selection of content.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A waterproof shower system 10 for installing in a shower to provide multiple functions, comprising:
a) a housing unit including at least one microphone 12 for receiving voice commands for operating the system;
b) a touch panel 14 for also manually operating the system;
c) a display screen 18 connected to the system for displaying multiple functions, including video and audio controls, weather information, news, sports information, and social media information;
d) speakers 70 for providing audio output;
e) a power source for providing power to the system;
f) a charging unit for recharging the shower system;
g) a proximity sensor for turning the system on when the user approaches the system; a motion sensor for turning the system on when the user approaches the system; and a light sensor for turning the system on when the light is turned on;
h) a processor 40 for controlling the operating software, and the video and the audio functions of the system; and
i) memory units 50 including a RAM unit 52 for providing temporary read-write storage off calculations and code executed by software applications running on the device, a ROM unit 54 for providing read-only storage of the operating system software, a video/graphics RAM unit 56 for providing temporary storage of the graphical and video data as it is being fed to the display screen, and a solid-state storage memory unit 58 for long-term, non-volatile storage of the software applications and their corresponding data.

2) A waterproof shower system in accordance with claim 1, wherein the housing unit includes a case having front and back case parts that are sealed to each other to provide a waterproof case.

3) A waterproof shower system in accordance with claim 1, wherein an impermeable waterproof layer is provided inside the case.

4) A waterproof shower system in accordance with claim 1, further including a magnetic wall mount for mounting the unit on the shower wall.

5) A waterproof shower system in accordance with claim 1, wherein the unit is wirelessly controlled.
